(19) United States
(12) Patent Application Publication
(10) Pub. No.: US 2009/0178534 A1
(43) Pub. Date: Jul. 16, 2009

(54) HAMMER SHANK AND SHANK BUTT FOR PIANO

(76) Inventors: Bruce E. Clark, Nottingham, NH (US); Kevin Burke, Haverhill, MA (US); Kirk Burgett, Sacramento, CA (US)

Correspondence Address: CRAIG A. SIMMERMON, 251 LYMAN CIR., SACRAMENTO, CA, 95835, US

(21) Appl. No.: 12/013,330

(22) Filed: Jan. 11, 2008

(51) Int. Cl. G10C 3/18

(52) U.S. Cl. 84/236; 84/243

(57) ABSTRACT

A hammer shank and shank butt for a grand piano with greatly improved rigidity and the collateral benefits of increased efficiency of manufacture and maintenance. Hammer shank comprises a long cylindrical member that is connected at one end to a traditional grand piano hammer and at the other end to a novel shank butt. Shank butt comprises: a hammer shank hole, a knuckle slot, a set of two flange attachment holes, and a void area. A traditional grand piano knuckle is attached to the knuckle slot. The shank butt is connected to the repetition flange of the piano. Thus, hammer shank is not directly connected to these members and thus can remain an integral cylindrical member without holes, notches, or voids, thereby allowing for a lighter, more rigid sub-member yielding hammer assembly with less mass. The invention provides the capability for a piano to be played with less touch weight on the keys and therefore provides a more responsive piano keyboard. The invention also allows for full “retrofitability” of hammer assembly into all existing grand piano brands. Embodiments include a composite shank butt that is a molded article and a composite hammer shank that is an extruded or molded article.

### BACKGROUND OF INVENTION

This invention relates to key operated percussion devices such as pianos and, more specifically, to the hammer assemblies of such devices. A hammer assembly comprises a hammer 40, hammer shank 30, and shank butt 20.

A piano produces sound as a result of a complicated mechanical chain reaction which starts with the pianist depressing a piano key which in turn actuates a piano action associated with the key which in turn rotates a hammer assembly associated with the piano action which in turn strikes a piano string or strings to make sound.

More specifically, a depressed key 10 gives rise to motion of the damper head assembly (not shown), separating the damper head from the associated set of strings, setting the strings ready to accept vibrations. The depressed key 10 also actuates the piano action 15 thereby pushing or “throwing” the associated hammer 40 and hammer shank 30 into the associated set of strings or string. The hammer 40 strikes the strings, generating a piano tone. The piano action 15 then receives or “catches” the hammer 40 and hammer shank 30 after it strikes the strings and rebounds back against the action 15. When the pianist releases the depressed key 10, the key 10 returns to the rest position, and permits the damper head assembly to return contact with the vibrating strings. The vibrations are absorbed by the damper head assembly, and the piano tone is terminated.

With a grand piano 45, a certain amount of kinetic energy is required when depressing a key 10 in order to move a hammer 40 as imparted by the piano action 15 to the integrated hammer shank (20 and 30). When a key 10 is depressed, the repetition base 70 is pushed up pivotally about the repetition flange 90. The jack 50 is moved upward together with the repetition base 70 pivotally about point 100 on the rotating repetition base 70. The jack 50 lifts the balancier 60, which pivots about the repetition base 70 at point 110. This raises the knuckle 80 along with the integrated hammer shank (20 and 30) thereby lifting the hammer 40 upwards towards the piano strings. The knuckle 80 slides along the guide surface of the balancier 60, causing the hammer 40 to move by rotation towards the set of horizontally stretched strings or string associated with that key 10. The hammer 40 moves with “free rotation” powered by the knuckle 80 sliding along the balancier 60. The hammer shank 30 is further rotated and disconnects from the balancier 60 in order for the hammer 40 to strike the strings.

Likewise, with an upright piano 115, a certain amount of kinetic energy is required when depressing a key 10 in order to move a hammer 40 as imparted by the piano action 15 to the shank butt 20 and hammer shank 30. As the key 10 is depressed, the wippen 120 is pushed up to pivotally move upward, causing the jack 130 to move up together with the wippen 120. The jack 130 is pivotally arranged on the wippen 120. The hammer 40 is then pushed up by the jack 130 through the shank butt 20, and pivotally moves toward a set of vertically stretched strings or string. Then, as the jack 130 comes into contact with a regulating button 150, the jack 130 is prevented from moving up and loses contact with the shank butt 20. The hammer 40 and hammer shank 30 continue to move upwards, without contact with the jack 130, and are thus thrown into the string or strings to create piano tone.

At this point, on both grand pianos and upright pianos, conventional wooden hammer shanks 30 bend somewhat before whipping around to strike the strings. This phenomenon can be verified by simple high speed photography of hammer motion resulting from practically every instance of piano playing. The more virtuosic the particular piano piece played, the greater the bending or deflection of the hammer shanks 30. This is because virtuosic piano pieces require greater key depression strength with faster key depression repetitions, which results in more forceful and more frequent hammer assembly rotations. As with all deflection motion, the greater the force applied on the body, the greater the deflection.

Since the energy absorbed by a bending of hammer shank 30 does not directly translate into the production of music, it is wasted energy or energy loss of the system. Thus, more key depression energy is required in order to produce music as a result of the bending of a hammer shank 30. Therefore, the elimination of hammer shank 30 deflection lowers the threshold energy requirement for the creation of sound. Hence the elimination of hammer shank 30 deflection results in a more responsive piano that requires less touch weight on the keys to play the piano.

The grand piano prior art consists of an integral shank butt 20 and hammer shank 30, hereafter known as an “integrated hammer shank”, made of wood, typically hornbeam or maple wood. The prior art does not consist of separate shank butt 20 and hammer shank 30 components. Prior art hammer shanks 30 come in one standard diameter or cross sectional area that can be thinned to reduce mass. The reduced mass is particularly required in the treble section because of the need to make the hammer rebound more quickly from the string. Prior art hammer shanks 30 are thinned on an increasing basis gradually as the pitch of the string or strings associated with the particular hammer shank increases. For manufacturing efficiency, this thinning is not continuous but rather is stepped by three separate groups—“thin”, “medium”, and “thick”. “Thick” hammer shanks are not trimmed at all and are used on the bass end of the piano. Hammers 40 are glued onto the hammer shank end of the integrated hammer shank (20 and 30). The integrated hammer shank (20 and 30) is connected to a hammer shank flange by a center pin. The shank flange is attached to the shank rail on the piano. The deflection referenced above occurs in the integrated hammer shank (20 and 30).

The applicants have conducted experimental analysis on grand piano integrated hammer shanks (20 and 30) made of hornbeam wood in order to determine their average rigidity. An integrated hammer shank (20 and 30) was clamped tight and secure on the shank butt end while weight was applied at 4.00″ from the clamping point. A 4″ effective length was used as this length is typical for grand piano integrated hammer shanks (20 and 30). Deflection 250 was measured at 3.79″ from the clamping point. Deflection 250 from various weights was recorded. See FIG. 3 for a depiction of the setup used to quantify the rigidity of the prior art integrated hammer shanks (20 and 30). The results of the deflection experiment are summarized in the table below.

### Prior Art Integrated Hammer Shank Rigidity Test

| | “Thick” HB | “Medium” HB | “Thin” HB |
|---|---|---|---|
| | Average | Average | Average |
| Weight Applied | Deflection | Deflection | Deflection |
| (lbs) | (inches) | (inches) | (inches) |
| 0 | 0 | 0 | 0 |
| 1.0 | 0.066 | 0.060 | 0.075 |
| 2.0 | 0.132 | 0.119 | 0.151 |
| 3.0 | 0.196 | 0.177 | 0.230 |
| 4.0 | 0.263 | 0.240 | 0.311 |
| 5.0 | 0.333 | 0.307 | 0.391 |
| 6.0 | 0.412 | 0.347 | 0.473 |

The relationship is linear, i.e. deflection 250 varies linearly in relation to the change in weight applied. Thus, the degree of deflection, which is inversely proportional to rigidity, of the integrated hammer shank (20 and 30) may be represented by a constant. In this case, the constant is given in the units of inches of deflection 250 per pound of weight applied and is determined by dividing the deflection number by the weight number listed above. The degree of deflection 250, defined as “deflectability”, of the hornbeam integrated hammer shank (20 and 30) going form thick, medium, to thin is 0.066 in/lbs, 0.060 in/lbs, and 0.077 in/lbs respectively. The standard deviation of these measurements is less than 0.0015 in/lbs in all cases. Note the smaller the deflectability measurement, the greater the rigidity of the integrated hammer shank (20 and 30). Also note that hornbeam wood has greater specific gravity than that of maple wood and is, thus, more rigid than maple wood. Therefore, hornbeam integrated hammer shanks (20 and 30) are more rigid than their maple counterparts.

The complicated mechanical chain reaction required to strike piano strings deeply affects the music generated by the piano. With most string instruments, the musician touches the strings directly with his hand or directly through a non-dynamic instrument such as a pick or a bow. Conversely, the pianist must depend on a series of mechanical actions, assembled from many small parts, to strike the strings. A pianist varies the speed, force, repetition, acceleration, timing, and other characteristics in near endless combinations when depressing and releasing keys in order to produce various piano tones to yield artistic piano music.

The preferred “feel” of a piano action has come into acceptance more from tradition rather than from methods associated with modern engineering and material science. In the early 1900's, manufacturers used the best available materials at the time, to practically produce high quality piano actions. Hardwood and felt were the primary materials used to produce piano actions at that time. For better or for worse, pianists, to this day, strongly prefer wood/felt actions simply because they deliver the feel consistent with what they grew up with, leading to the propagation of more wood/felt actions, leading to newer generations of pianists learning to play on wood/felt actions, leading to the same preference with new generations, and so on.

Relative to more modern materials, such as composites or plastics, wood is an inefficient raw material from which to manufacture piano action components. Wooden action pieces must be drilled to produce the holes required for pivotal connections and assembly with other action components. The hole-drilling process is a laborious and costly process as compared to the production of molded piano action pieces with holes accurately formed therein during the initial molding process. Also, the production of any finished wooden piece necessarily involves relatively large quantities of wasted material in the form of saw dust, which is inefficient and wasteful.

Wood is hydroscopic, i.e. wood swells or shrinks as its moisture content changes in response to the environmental. This can cause binding in the action. Additionally, after repeated occurrences, this causes compression of the wood leading to failure of the piano action component. For instance, wooden flanges often crack due to expansion from a rise in moisture content, as the screw crushes the wood in the flange where it is fastened to the rail.

Moreover, wood has different strengths in different directions, complicating manufacturing processes, also resulting in reduced manufacturing efficiencies. Additionally, wood has inferior rigidity and strength as compared to modern composites and plastics. In particular, rigidity and strength is of the utmost importance to the hammer assembly portion of the complicated mechanical chain reaction of a piano.

Finally, the lifespan of wooden piano action components is limited as compared to that of other materials such as composites or plastics because wood eventually crumbles into dust after a certain amount of environmental cycles. On the other hand, composite piano action components would have several times the life span of that of their wood counterparts and thus result in more efficient manufacture and maintenance of a piano.

### OBJECT OF INVENTION

It is an object of this invention to provide a new hammer assembly for a piano that requires less initial energy from the pianist's fingers in order to deliver the same sound of that generated by currently available traditional wooded hammer assemblies. This can be accomplished by the elimination or substantial reduction thereof of hammer assembly deflection, without increasing the weight of the hammer assembly. Thus, it is an object of this invention to yield an improved hammer assembly with substantially increased stiffness or rigidity that can be retrofitted into any existing piano, thereby effectively providing the piano with a more responsive keyboard that requires less touch weight to play.

Additionally, it is an object of this invention to yield a hammer assembly with the collateral benefits of increased efficiency of manufacture and maintenance over those of their corresponding wood counterparts. Thus, it is an object of this invention to yield a more rigid hammer assembly with the additional benefits of increased efficiency of manufacture and maintenance.

### BRIEF DESCRIPTION OF THE DRAWINGS

FIG. 1 is a cross sectional view of a generic grand piano.

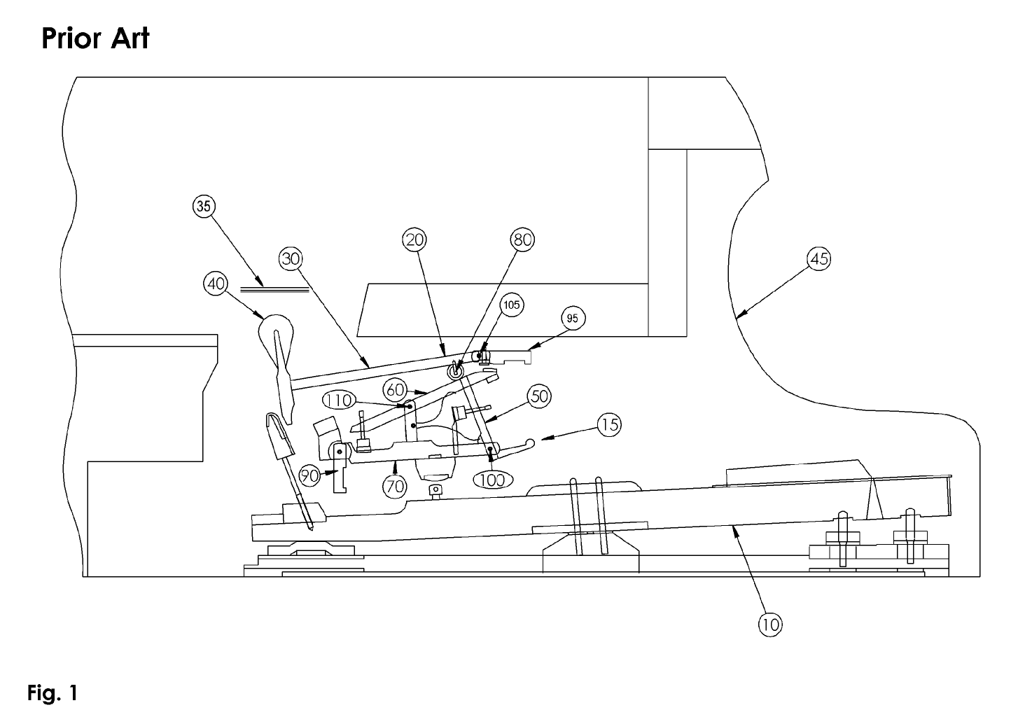

FIG. 2 is a cross sectional view of a generic upright piano.

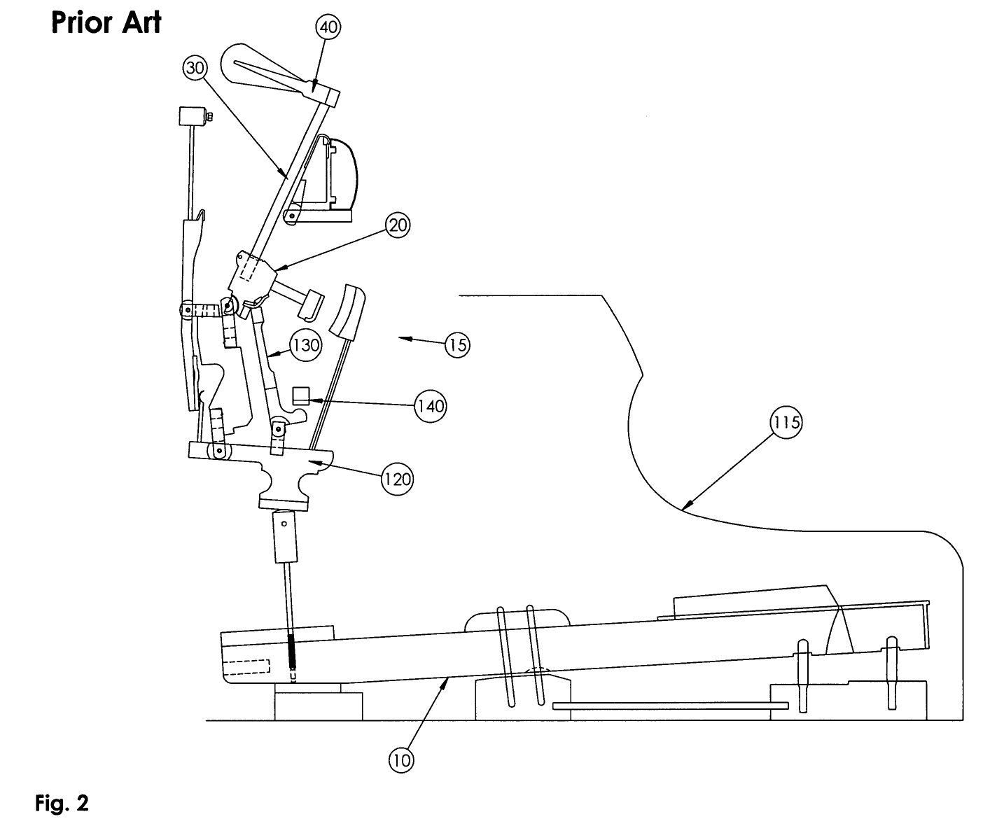

FIG. 3 is a side view of the experimental setup used to measure hammer shank rigidity.

FIG. 4 is a magnified view of one end of a grand piano shank butt.

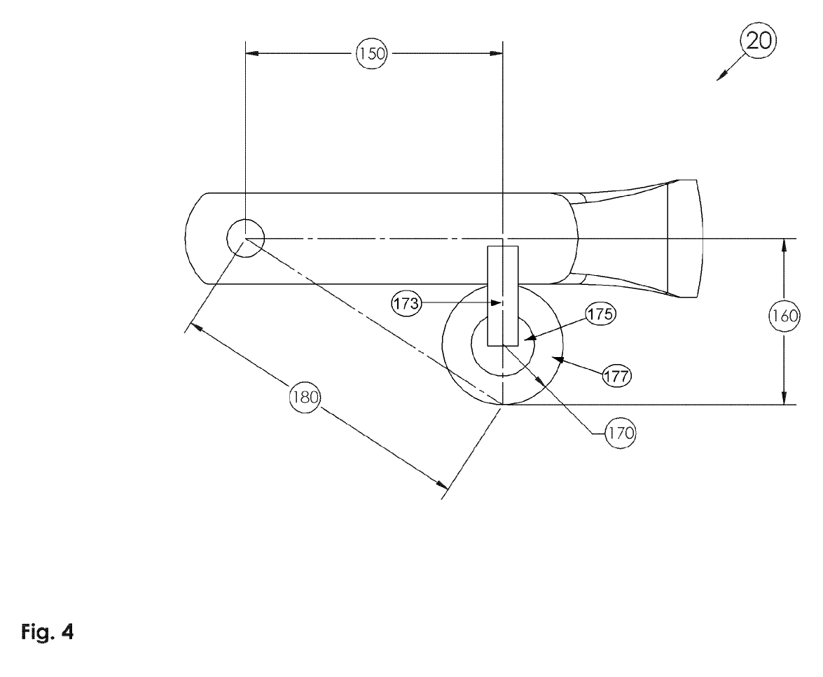

FIG. 5 is a perspective view of a grand piano shank butt.

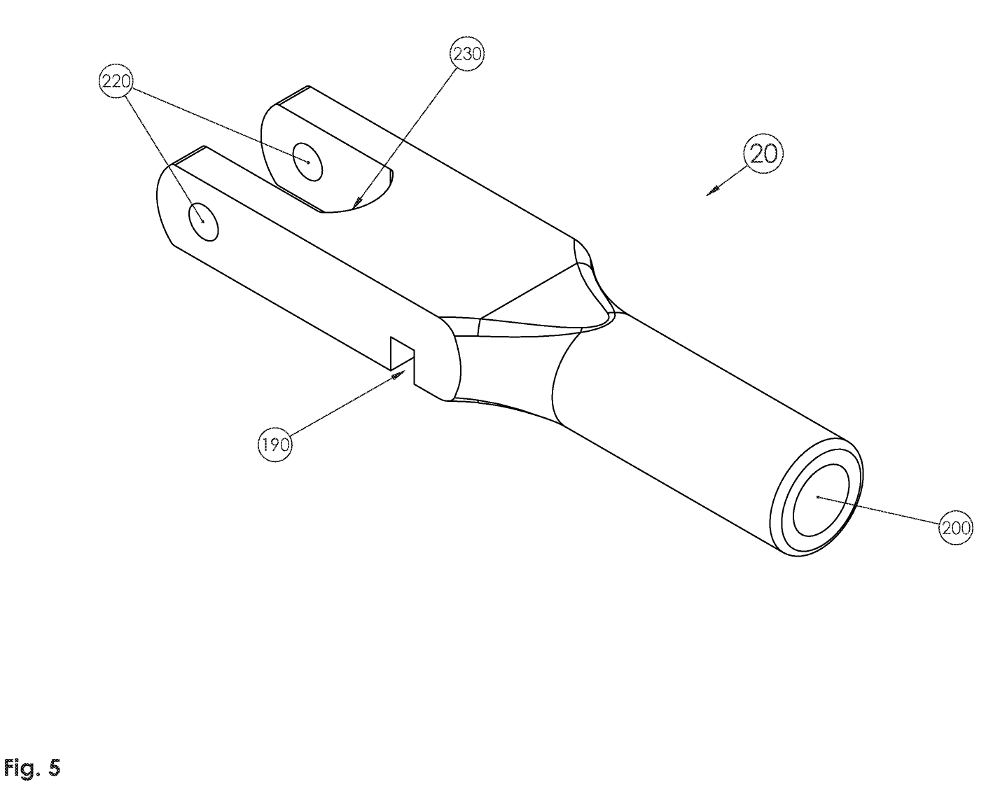

FIG. 6 is a side view is a grand piano hammer shank/shank butt assembly.

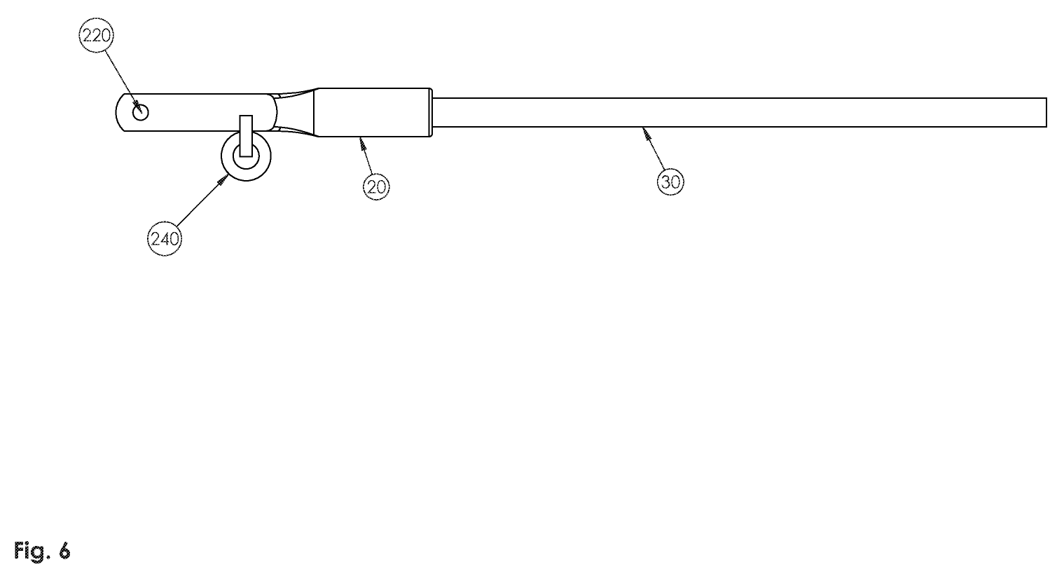

FIG. 7 is a perspective view of a grand piano hammer shank/shank butt assembly.

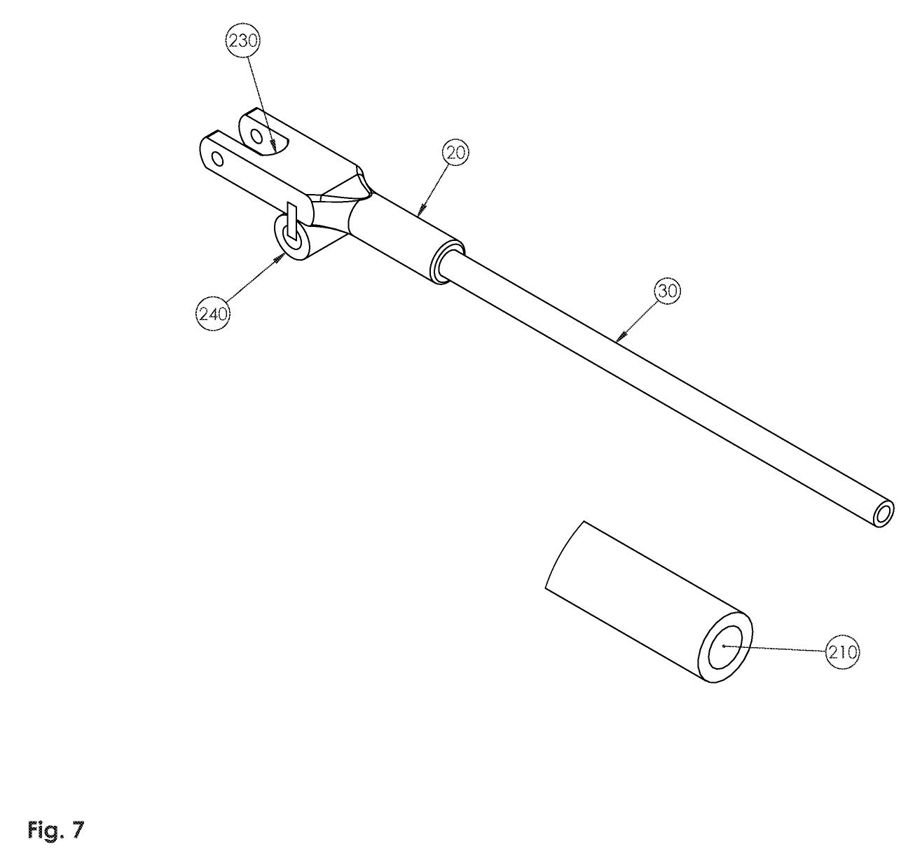

### DEFINITION LIST

| Term | Definition |
|---|---|
| 10 | Piano Key |
| 15 | Piano Action |
| 20 | Shank Butt |
| 30 | Hammer Shank |
| 40 | Hammer |
| 45 | Grand Piano |
| 50 | Grand Piano Jack |
| 60 | Grand Piano Balancier |
| 70 | Grand Piano Repetition Base |
| 80 | Grand Piano Knuckle (prior art) |
| 90 | Grand Piano Repetition Flange |
| 100 | Grand Piano Jack Pivot Point |
| 110 | Grand Piano Balancier Pivot Point |
| 115 | Upright Piano |
| 120 | Upright Piano Wippen |
| 130 | Upright Piano Jack |
| 140 | Upright Piano Regulating Button |
| 150 | Shank Butt Center-to-Center Distance |
| 160 | Shank Butt Protrusion |
| 170 | Knuckle Diameter |
| 180 | Shank Butt Lower Lever Arm |
| 190 | Knuckle Slot on Shank Butt |
| 200 | Hammer Shank Hole on Shank Butt |
| 210 | Hollow Center of Best Mode Hammer Shank |
| 220 | Flange Attachment Holes on Shank Butt |
| 230 | Hollow Area on Shank Butt |
| 240 | Knuckle on Shank Butt |
| 250 | Deflection Amount |

### DETAILED DESCRIPTION OF EMBODIMENT(S)

A hammer assembly consists of a hammer 40, a hammer shank 30, and a shank butt 20. This invention includes novel hammer shanks 30 and novel shank butts 20 that can be attached to prior art hammers 40, which are made of wood and felt, typically hornbeam wood and felt. The novel hammer shanks 30 and novel shank butts 20 can be installed into any piano, both grand and upright pianos.

A grand piano shank butt 20 has two flange attachment holes 220, which are used to install a hinge pin in order to create a pivotal connection to a shank flange. A grand piano shank butt 20 also includes a hollow area 230, which is necessary to allow clearance for the shank butt 20 to pivotally rotate about the shank flange.

More than one diameter hammer shank 30 is used in a typical piano. Thus, the invention includes separately designed shank butts 20, each with an appropriated sized hole 200, to accept the various hammer shank 30 diameters in the public domain. In addition, the invention includes separately designed shank butts 20, each with an appropriately sized hole 200, to accept the various sized hammer shank 30 diameters incorporated in this invention.

A grand piano shank butt 20 has a knuckle 240. The knuckle 240 transmits energy from the upward moving jack 50 to the knuckle 240 mounted on the shank butt 20. The knuckle 240 is attached to the shank butt 20 at the knuckle slot 190 and is typically attached by glue. The knuckle 240 is made of buckskin or synthetic buckskin with a resilient core. As the jack 50 moves upwards as the result of a keystroke, the knuckle 240 also moves upwards, thereby pushing the shank butt 20 upwards, which in turn pushes the hammer shank 30 upwards.

The leverage applied to the hammer assembly of a grand piano may be adjusted according to certain criteria of the shank butt 20. These criteria are shank butt center-to-center 150, shank butt protrusion 160, knuckle diameter 170, and shank butt lower lever arm 180. Center-to-center 150 is varied by adjusting the location of the knuckle slot 190 on the shank butt 20. Protrusion 160 is varied by adjusting the knuckle diameter 170. Together, these two criteria determine the shank butt lower lever arm 180. Typically, different brands of piano require specific shank butt center-to center sizes 150 and specific shank butt protrusion sizes 160. This invention includes shank butts with all center-to-center sizes 150 and protrusion sizes 160 to fit any grand piano in the public domain.

All shank butts 20 of this invention are made of composite material or plastic material. Composite is defined as an engineered material made from two or more constituent materials with significantly different physical or chemical properties and which remain separate and distinct on a macroscopic level within the finished structure. Composites and plastics yield advantages over wood, relating to efficiency of manufacture and maintenance, as discussed in the back ground of invention section. Composite and plastic shank butts 20 can be more efficiently produced at a greatly improved accuracy and precision over their wooden counterparts. Additionally, composite material with filler additives provide the capability for increased stiffness of the parts, which is extremely important to the responsiveness and touch weight requirement of any piano. Best mode shank butts 20 are made of 6/6 Nylon with 50% long glass fiber. This material is currently considered the best mode as it yields the best combination of performance, i.e. rigidity, and price. For instance, glass filler is considerably less costly than carbon filler. As the cost of composites or plastics with different filler materials fluctuates with economic trends, a new best mode material will likely be chosen.

All hammer shanks 30 of this invention are essentially cylindrically shaped made from composite or plastic material with an overall outer diameter range of 1-8 mm. Such hammer shanks 30 can be manufactured with less weight and more rigidity than their wooden counterparts. This is particularly so when the hammer shank 30 is made of hollow form because hollow parts naturally weigh less than non-hollow parts. Thus, the best mode hammer shank 30 of this invention is hollow in the center as depicted at 210. The hollow cross section of the shank 30 does not have to be round, but typically is so. Likewise, the outer cross section of the shank 30 does not have to be round, but typically is so. Hollow hammer shanks are typically most efficiently produced by an extrusion process.

Rigidity of a hammer shank 30 can be increased even more so when constructed from materials with additive fiber fillers. Many fiber fillers can be used for this purpose like glass, Kevlar, carbon, or ceramic to increase rigidity. However, in the case of extruded parts, carbon fillers are the best of the aforementioned because carbon fibers tend to tear apart less during the extrusion process as compared to other fillers like glass. As stated above, hollow hammer shanks are better because they weigh less and are most efficiently made by extrusion, thus, carbon fiber filler has been chosen as the best mode for the composite hammer shank 30. The extra cost of carbon fiber is required to combat the fiber breakdown problem associated with glass fiber extrusions.

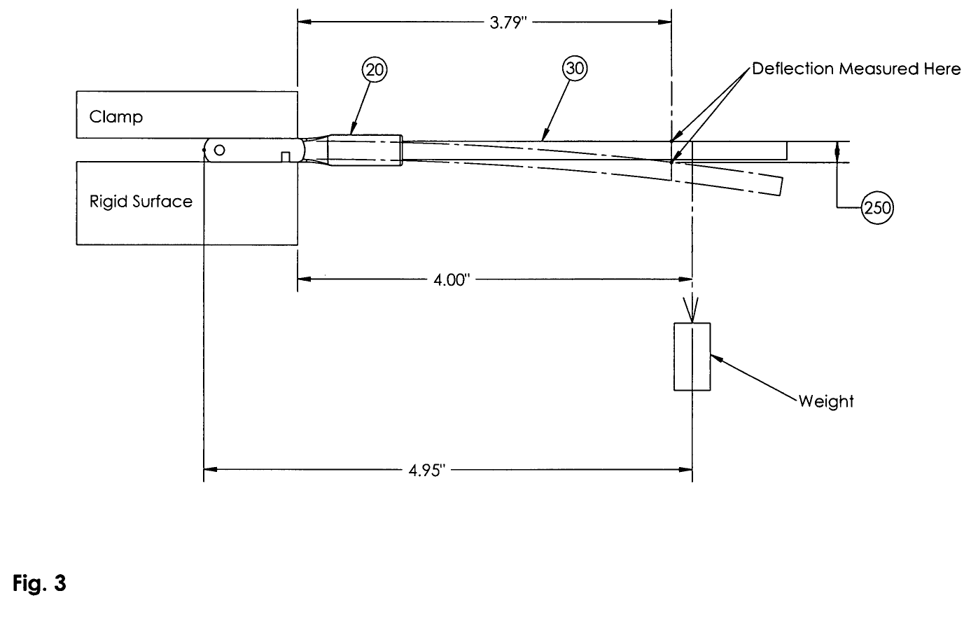

The applicants have conducted experimental analysis to determine the rigidity of the best mode hammer shank 30. As with the prior art experimental analysis, a hammer shank/shank butt (20 and 30) was clamped tight and secure on the shank butt end while weight was applied at 4.00″ from the clamping point. A 4″ length of hammer shank 30 was used as this length is typical for both grand piano and upright piano hammer shank/shank butt assemblies or integrated hammer shanks. Deflection 250 was measured at 3.79″ from the clamping point. Deflection 250 from various weights was recorded. See FIG. 3 for a depiction of the setup used to quantify the rigidity of the best mode hammer shank 30. The results of the deflection experiment are summarized in the table below.

### Best Mode Hammer Shank/Shank Butt Assembly Rigidity Test

| | “Thick” Composite | “Medium” Composite |
|---|---|---|
| | Average | Average |
| Weight Applied | Deflection | Deflection |
| (lbs) | (inches) | (inches) |
| 0 | 0 | 0 |
| 1.0 | 0.028 | 0.050 |
| 2.0 | 0.061 | 0.102 |
| 3.0 | 0.094 | 0.154 |
| 4.0 | 0.128 | 0.207 |
| 5.0 | 0.162 | 0.262 |
| 6.0 | 0.197 | 0.316 |

The relationship is linear, i.e. deflection 250 varies linearly in relation to the change in weight applied. Thus, the degree of deflection, which is inversely proportional to rigidity, of the hammer shank 30 may be represented by a constant. In this case, the constant is given in the units of inches of deflection per pound of weight applied and is determined by dividing the deflection number by the weight number listed above. The degree of deflection 250, defined as “deflectability”, of the best mode hammer shanks 30 going from thick to medium is 0.031 in/lbs and 0.052 in/lbs respectively. The standard deviation of these measurements is less than 0.0017 in/lbs in all cases. Note the smaller this measurement, the greater the rigidity of the hammer shank 30. Thus, the best mode “thick” hammer shank 30 achieved an increase in rigidity over the prior art counterparts by 53%. The best mode “medium” hammer shank 30 achieved an increase in rigidity over the prior art counterparts by 14%.

Since the best mode hammer shank 30 has a hollow center, a thicker overall hammer shank 30 diameter may be used without a significant weight increase, as compared to that of prior art hammer shanks 30. Taking this into account, it is feasible to use the “thick” diameter composite hammer shank 30 for every key in the piano, without sacrificing hammer shank weight limitations. Thus, instead of using three diameters of hammer shanks 30 in any one piano, all “thick” diameter composite hammer shanks 30 may be used throughout. If the invention is used in this capacity, the new hammer shank 30 can be used to increase rigidity by 52%, 48%, and 60% over the prior art thick, medium, and thin horn beam integrated hammer shanks respectively. This is a very substantial improvement in rigidity of these assemblies.

1. A hammer assembly for a grand piano which is pivotally moved with depression of a piano key comprising: a hammer: a hammer shank: a shank butt: and a knuckle, wherein said shank butt further comprises: a hammer shank hole (200): a knuckle slot (190): a set of two flange attachment holes (220): and a void area (230).

2. A hammer assembly for a grand piano as in claim 1, wherein one end of said hammer shank is affixed to said shank butt inside said hammer shank hole and the other end of said hammer shank is affixed to said hammer, which is a traditional grand piano hammer, and said knuckle, which is also of traditional type with a conical resilient core (175) and a wood spline (173), is affixed to said shank butt by affixing said spline inside said knuckle slot, to form said hammer assembly.

3. A hammer assembly for a grand piano as in claim 2, wherein said flange attachment holes receive there through a hinge pin where said hinge pin is connected to a shank flange of a grand piano, to create a pivotal connection between said shank butt and the shank flange, and said hollow area is required as clearance for the pivotal action between said shank butt and the shank flange.

4. A hammer assembly for a grand piano as in claim 2 wherein said hammer, said hammer shank, said shank butt, and said knuckle are affixed together by glue.

5. A hammer assembly for a grand piano as in claim 2 wherein said hammer shank and said shank butt are made of plastic or composite material.

6. A hammer assembly for a grand piano as in claim 2 wherein said shank butt further comprising a means to vary a lower lever arm vector dimension (180).

7. A hammer assembly as in claim 6 wherein said means to vary a lower lever arm vector dimension is accomplished by:
a) a custom molding of said shank butt wherein said custom molding comprises a specific center-to-center dimension (150), and
b) a specifically sized said conical resilient core with proper diameter to yield a specific knuckle diameter (170) or protrusion dimension (160),
thereby yielding said shank butt with a specific lower lever arm vector dimension (180).

8. A hammer assembly for a grand piano as in claim 7 wherein said hammer, said hammer shank, said shank butt, and said knuckle are affixed together by glue.

9. A hammer assembly for a grand piano as in any of the preceding wherein said hammer shank and said shank butt are both made of plastic or composite with glass fiber, carbon fiber, Kevlar fiber, or ceramic filler material and said hammer shank has a hollow center.

10. A shank butt for a grand piano as in claim 9 that is made of Nylon plastic with 40-60% glass fiber filler material.
